(19) United States
(12) Patent Application Publication
(10) Pub. No.: US 2025/0100943 A1
(43) Pub. Date: Mar. 27, 2025

(54) Foam Concrete and Composition and Method of Forming Same

(71) Applicant: City University of Hong Kong, Kowloon (HK)

(72) Inventors: Denvid Lau, Kowloon (HK); Huaguo Chen, Kowloon (HK); Kaikang Liang, Kowloon (HK)

(21) Appl. No.: 18/892,670

(22) Filed: Sep. 23, 2024

Related U.S. Application Data
(60) Provisional application No. 63/585,848, filed on Sep. 27, 2023.

(51) Int. Cl. C04B 38/10; C04B 18/18; C04B 28/14; C04B 103/00; C04B 103/40

(52) U.S. Cl. CPC C04B 38/10; C04B 7/02; C04B 14/106; C04B 18/18; C04B 28/14; C04B 2103/0093; C04B 2103/402; C04B 2111/00017

(57) ABSTRACT

A foam concrete composition (28) is disclosed as including limestone calcined clay cement (LC³) (20), used engine oil (UEO) (14), a foaming agent (10), and water (12). A method of forming a foam concrete composition is disclosed as including mixing limestone calcined clay cement (LC³) (20), used engine oil (UEO) (14), a foaming agent (10) and water (12).

This application claims priority from U.S. Patent Application No. 63/585,848 filed on 27 Sep. 2023, the content of which being incorporated herein by reference in its entirety as if fully set forth herein.

### BACKGROUND OF THE INVENTION

The construction industry is a major contributor to CO₂ production, as it is responsible for 25% to 38% of global greenhouse gas emissions. Within this industry, cement manufacturing and heating/cooling of building operations are the primary causes of CO₂ emission, accounting for 6.9% and 6% of global emissions respectively. Given its significant carbon contribution, achieving carbon neutrality by 2050 remains a key milestone for the construction sector. De-carbonization of the building sector encapsulates worldwide efforts to provide a sustainable built environment with minimal CO₂ emissions. Among these efforts, innovations in low-carbon and energy-efficient construction materials can have significant environmental benefits in terms of intrinsically realizing long-term de-carbonization. Utilizing such materials could reduce carbon emissions in the material production process (e.g., the calcination process in cement production) and improve the energy efficiency of buildings. As such, the strategic selection of sustainable materials significantly contributes to the wide-ranging effort to achieve global carbon neutrality.

Foam concrete (also called “lightweight foam concrete,” “lightweight cellular concrete” (LCC) and “low density cellular concrete” (LDCC)) shows significant potential for de-carbonizing the building sector due to its life-cycle carbon reduction characteristic encompassing material usage, manufacturing process, and service stage. As a low-density material, foam concrete requires less raw material and energy for transportation and production, reducing carbon emissions. Moreover, the manufacturing process of foam concrete reduces carbon emissions by around 50% compared to traditional concrete, offering a practical solution for lessening the carbon footprint of the building industry. Moreover, the superior heat insulation properties of foam concrete render it particularly advantageous during the service stage of buildings, wherein it yields substantial energy savings. Specifically, its thermal insulation ability helps maintain indoor temperature stability and reduce the energy required for heating and cooling, resulting in less carbon emission throughout the operational lifespan of buildings. The life-cycle carbon reduction properties of foam concrete make it a promising option for the de-carbonization of the construction sector.

While foam concrete has great carbon reduction potential, maintaining foam structure stability prior to concrete setting is pivotal to its successful manufacturing and implementation. Stability refers to the ability of foam liquid film to maintain its structure independence, avoiding degradation such as bubble coarsening, foam drainage, and rupture. To address the common instability issue with surfactant-based foaming agents, which are widely employed, foam stabilizers or gas-liquid interface modifiers have been used to extend foam lifespan and enhance stability. The working principle of foam stabilizers revolves around enhancing the dilatational viscoelasticity of the foaming liquid film, which results in a thickened Plateau border, as shown by scanning electron microscopy (SEM). This thickened border strengthens the resistance of foam to gas diffusion in the foam film and mechanical stress, leading to foam stabilization and yielding final foam concrete with the desired mechanical, thermal, and sound insulation attributes. Current foam stabilizers, mainly nanomaterials, polymer chains, and surfactant monomers, exhibit sound stabilization performance. However, their industrial-level applications are meeting some challenges. For instance, nanomaterials and polymer chains are costly to produce, limiting their widespread use, while surfactant monomers, although more affordable and accessible, may not provide the same stability.

In addition to foam stabilizers, the selection of cement for foam concrete is critical for enhancing its foam stability. Traditional ordinary Portland cement (OPC) has a long setting time, negatively impacting foam stabilization. Particularly, during the setting and hardening of concrete, the foam bubbles compress and lose shape, leading to foam collapse. Moreover, the cement hydration process depletes the free water needed to maintain foam integrity, making it more prone to collapse. In addition to technical concerns, the use of carbon-intensive OPC also raises environmental concerns. Thus, to achieve stable foamability and improve the sustainability of foam concrete products, it is critical to identify low-carbon cementitious materials with reduced setting times.

It is thus an object of the present invention to provide a foam concrete composition, a foam concrete, a method of forming a foam concrete composition, and a method of forming a foam concrete in which at least one of the above shortcomings is mitigated, or at least to provide a useful alternative to the trade and public.

### SUMMARY OF THE INVENTION

According to a first aspect of the present invention, there is provided a foam concrete composition, including limestone calcined clay cement (LC³), used engine oil (UEO), a foaming agent, and water.

According to a second aspect of the present invention, there is provided a foam concrete formed of a foam concrete composition including limestone calcined clay cement (LC³), used engine oil (UEO), a foaming agent, and water.

According to a third aspect of the present invention, there is provided a method of forming a foam concrete composition, including mixing limestone calcined clay cement (LC³), used engine oil (UEO), a foaming agent and water.

According to a fourth aspect of the present invention, there is provided a method of forming a foam concrete, including forming a foam concrete composition, including mixing limestone calcined clay cement (LC³), used engine oil (UEO), a foaming agent and water.

### BRIEF DESCRIPTION OF THE DRAWINGS

Embodiments of the present invention will now be described, by way of examples only, with reference to the accompanying drawings, in which:

FIG. 1(a) shows structural formulae of components of used engine oil (UEO) which may be used in the present invention;

FIG. 1(b) shows structural formulae of components of foaming agents which may be used in the present invention;

FIGS. 2(a) to 2(c) show schematically a method of forming a UEO-enhanced lightweight LC³ foam concrete according to an embodiment of the present invention;

FIG. 3(a) shows a setup for conducting foam volume tests;

FIG. 3(b) shows an electron microscope suitable for conducting foam microscopy tests;

FIG. 3(c) shows a setup for conducting compressive strength tests;

FIG. 3(d) shows a setup for conducting SEM analysis;

FIG. 3(e) shows a setup for conducting thermal conductivity tests;

FIG. 3(f) shows a setup for conducting macroscopic thermal insulation test;

FIG. 4(a) shows foam volume evolution over time;

FIG. 4(b) shows the height evaluation of foam volume, in which Tt represents the onset of foam collapse, marking the transition between Regime I and Regime II;

FIG. 4(c) shows the correlation between Tt and the dosage level of UEO;

FIG. 4(d) shows the correlation between the remaining foam fraction and the UEO dosage level;

FIG. 5(a) shows a microscopy photograph of a foam mixture without UEO at a foam surface;

FIG. 5(b) shows a microscopy photograph of a foam mixture with 1 wt. % UEO;

FIG. 5(c) shows a microscopy photograph of a foam mixture with 2 wt. % UEO;

FIG. 5(d) shows a zoomed-in microscopy photograph of a foam mixture without UEO;

FIG. 5(e) shows a zoomed-in microscopy photograph of a foam mixture with 1 wt. % UEO;

FIG. 5(f) shows a zoomed-in microscopy photograph of a foam mixture with 2 wt. % UEO;

FIG. 5(g) shows foam size changes as UEO addition dosage increases;

FIG. 5(h) illustrates the relevant gas-liquid interface change in the present invention;

FIG. 6(a) shows compressive strength of foam concrete with various UEO doses;

FIG. 6(b) shows changes in the compressive strength of the foam concrete according to the present invention in comparison with the reference foam concrete;

FIG. 7(a) is a thermal image of the initial stage of reference foam concrete without UEO;

FIG. 7(b) is a thermal image of the reference foam concrete of FIG. 7(a) after a two-hour conditioning period;

FIG. 7(c) shows the evolution of temperature over time at spots 1 and 2 for the reference foam concrete of FIG. 7(a);

FIG. 7(d) is a thermal image of the initial stage of foam concrete incorporating 1 wt. % UEO;

FIG. 7(e) is a thermal image of the foam concrete with 1 wt. % UEO of FIG. 7(d) after a two-hour conditioning period;

FIG. 7(f) shows the evolution of temperature over time at spots 1 and 2 for the foam concrete with 1 wt. % UEO of FIG. 7(d);

FIG. 7(g) is a thermal image of a normal concrete with the same water-to-cement ratio as foam concrete at the initial stage;

FIG. 7(h) is a thermal image of the normal concrete of FIG. 7(g) after a two-hour conditioning period;

FIG. 7(i) shows the evolution of temperature over time at spots 1 and 2 for the normal concrete of FIG. 7(g);

FIG. 8(a) shows pores with various sizes in sample U0;

FIG. 8(b) shows pores with more uniform sizes in sample U10;

FIG. 8(c) shows pores with large sizes in sample U20

FIG. 8(d) shows thin and sharp ettringite crystals along the borders of the pores in sample U0;

FIG. 8(e) shows long and wide ettringite crystals in sample U10;

FIG. 8(f) shows long and narrow ettringite crystals in sample U20;

FIG. 8(g) shows porous microstructure in sample U0;

FIG. 8(h) shows densely packed microstructure in sample U10; and

FIG. 8(i) shows large pores in sample U20.

### DESCRIPTION OF THE EMBODIMENTS

Typically, “used engine oil” (“UEO”) includes engine oil that has seen service in various transportation vehicle engines (such as motor cars, private cars, and heavy vehicles) for a period typically exceeding six months. During this time period, the density of UEO often falls within a unique range, which is generally lower than that of new engine oil. This density variation reflects the operational wear, breakdown of constituents, and introduction of contaminants such as wear particles (including metal shavings, soot, and sludge) and other impurities (like dust, water, and oxidation products).

It is found that used engine oil (UEO), which is an abundant urban and industrial waste, represents a potential alternative to conventional foam stabilizers, due to its high viscosity and large-scale hydrocarbon chains. Specifically, the aggregated and viscous UEO molecules can increase the viscosity of the foam fluid against drainage and coalescence, bolstering the Plateau border against mechanical stress. It has been reported that oil phase distribution within the foam structure strengthens foam films and thickens the Plateau border. Moreover, the intertwined-net structures of UEO can limit water molecule mobility in bubble channels, narrowing the cross-section of the liquid foam channel. Furthermore, the active sulfonate groups in UEO contribute to its plasticizing effect on fresh cement mixture, ensuring foam uniformity and creating strong borders around pores and refined pore structures. It is thus believed that UEO has great potential as an effective foam stabilizer. However, exceeding a UEO dosage threshold can cause anti-foaming behavior and foam collapse due to the threshold dose effect. The present invention is based on results of research on the feasibility and appropriate dosage of use of UEO in the production of foam concrete, thus facilitating waste-to-resource transformation.

On the other hand, limestone calcined clay cement (“LC³”), which is a blend of clinker, limestone and calcined clay, offers a low-carbon, faster-setting alternative to ordinary Portland cement (OPC). LC³ reduces clinker usage and its production process emits less carbon dioxide due to a lower process temperature. Quantitatively, LC³ emits around 30-50% less carbon dioxide per ton of cement produced, making it a sustainable alternative to OPC. In addition, LC³ sets faster, typically in six hours compared to seven hours required by OPC; this improves foam stability and reduces foam collapse likelihood. This increased setting speed also enhances production efficiency by enabling faster curing times and shorter construction periods. Therefore, the use of LC³ in foam concrete production can be an efficient and sustainable solution for improving foam concrete performance and reducing the carbon footprint of OPC production.

This invention aims to improve the foam stability and sustainability of foam concrete, and thereby to contribute to the deep de-carbonization of the construction industry. A low-carbon, waste-enhanced, low-density LC³ foam concrete has been devised, wherein UEO and LC³ function as a waste-transformed foam stabilizer and sustainable cement, respectively. The technical feasibility of such foam concrete was validated by assessing key performance metrics including foam stability, compressive strength, and thermal insulation coefficient. The latent mechanisms driving the performance changes were revealed by microscopic techniques, which helped to elucidate foam characteristics such as border thickness, foam size, and the pore system within the concrete.

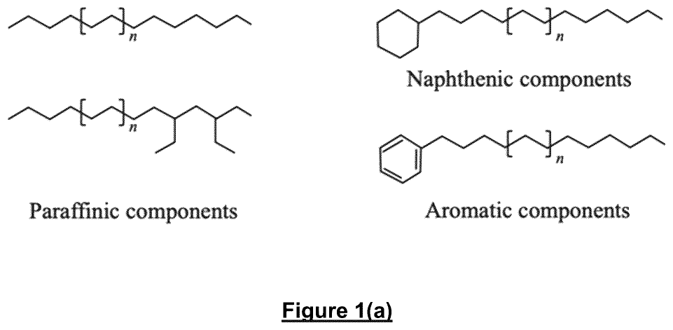

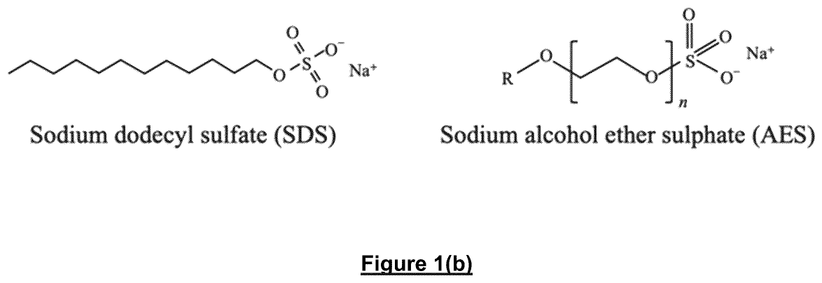

The materials used for producing the low-carbon foam concrete include UEO, LC³, a foaming agent, and water (such as tap water). The UEO used was Delo® Gold Ultra SAE 15 W-40 from Chevron Corporation, a multigrade and heavy-duty diesel engine oil designed for various engines. This UEO, which had been in operation for six months and was of a density of 0.848 g/cm³, was obtained from a generator engine. Generally, UEO of a density of 0.6-2.0 g/cm³ may be used. As shown in FIG. 1(a), UEO primarily contains long-chain paraffin (15-30 carbon atoms) and naphthenes, with side chains up to 20 carbons long, alongside minor constituents of aromatic components with benzene rings and saturated side chains.

The foaming agent may be of a foaming ratio of from 1:30 to 1:50. The foaming ratio refers to the volume of foam produced per unit volume of the foaming agent solution. For example, a foaming ratio of 1:30 means that one unit volume of the foaming agent solution will produce 30 unit volumes of foam. The foaming agent used was DAREX® AE S45 foam concentrate by GCP Applied Technologies Inc., consisting of sodium dodecyl sulfate (SDS) and sodium alcohol ether sulphate (AES), as shown in FIG. 1(b). Following the user manual, the Darex AE S45 concentrate was premixed at a ratio of 1:40 mass parts with water to yield the foam with a density of approximately 65 kg/m³. The LC³ blend is consisted of 50 wt. % Type I ordinary Portland cement, 30 wt. % metakaolin (calcined kaolinite clay), 15 wt. % limestone, and 5 wt. % gypsum. The proportions of the components in the LC³ blend may be fine-tuned ±5% to optimize performance of the foam concrete while retaining blend integrity and effectiveness.

The physical properties and oxide composition of the LC³ are shown in Table 1.

TABLE 1
Physical properties and oxide composition of LC³ blend.

| | | Calcined | | |
|---|---|---|---|---|
| Materials | OPC | kaolinite clay | Limestone | Gypsum |
| K₂O (wt. %) | 0.45 | 0.1 | — | — |
| Na₂O (wt. %) | 0.2 | 0.3 | 0.1 | — |
| Fe₂O₃ (wt. %) | 2.58 | 0.37 | 0.02 | — |
| SO₃ (wt. %) | 3.43 | 0.1 | 0.08 | — |
| MgO (wt. %) | 1.53 | — | 0.2 | 47.14 |
| SiO₂ (wt. %) | 19.61 | 54.97 | — | — |
| Al₂O₃ (wt. %) | 5.72 | 42.85 | 0.07 | — |
| CaO (wt. %) | 65.17 | — | 55.14 | 33.36 |
| Chloride (wt. %) | — | — | — | — |
| Loss on ignition (wt. %) | 1.12 | 1.12 | 44.12 | 21.16 |
| Bulk density (g/cm³) | 3.12 | 2.63 | 2.7 | 2.86 |

Note:
— represents a negligible value.

Table 2 shows the design mix of the low-carbon foam concrete according to the present invention. The specific water-to-cement (w/c) weight ratio, fresh density, and UEO addition dosages were determined as follows. Foam concrete according to the present invention typically has a w/c weight ratio ranging from 0.3 to 0.6. A low w/c weight ratio causes a stiff mix and foam breakage during mixing, while foam concrete with a high w/c weight ratio lacks the strength to hold the bubbles, causing segregation. Thus, a balanced w/c weight ratio of 0.45 was chosen in order to maintain foam stability and long-term concrete durability. A fresh density of 620 kg/m³, estimated to correspond to a dry density of 600 kg/m³, was set, as foam concrete used as lightweight building insulation material typically has a dry density between 400 kg/m³ and 800 kg/m³. Foam stabilizer dosage for foam concrete typically varies from 0.5% to 2% by weight of the foam generated. To investigate the optimal UEO dosage that can be incorporated into foam concrete without compromising foam stability, the UEO addition levels were set at 0, 0.5 wt. %, 1 wt. %, 1.5 wt. % and 2 wt. % in the respective foam concrete samples U0, U05, U10, U15, and U20 (all with respect to the weight of the foam generated).

TABLE 2
Design mix proportions of the foam concrete
with and without UEO (kg/m³)

| | | | | Foam |
|---|---|---|---|---|
| Mix | UEO | Water | LC³ | agent |
| U0 | 0 | 180 | 400 | 1 |
| U05 | 0.05 | 180 | 400 | 1 |
| U10 | 0.10 | 180 | 400 | 1 |
| U15 | 0.15 | 180 | 400 | 1 |
| U20 | 0.20 | 180 | 400 | 1 |

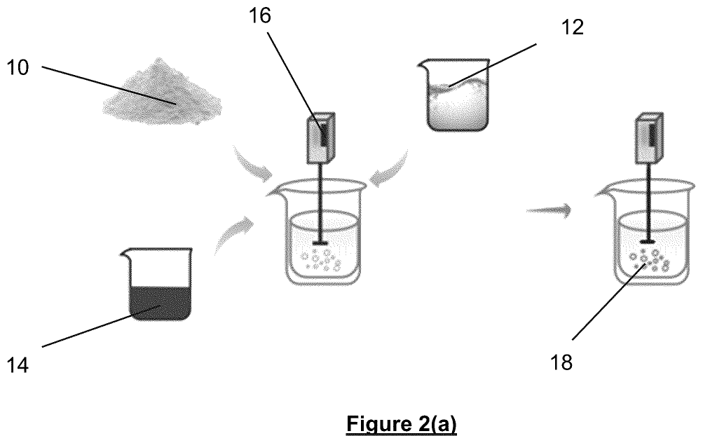

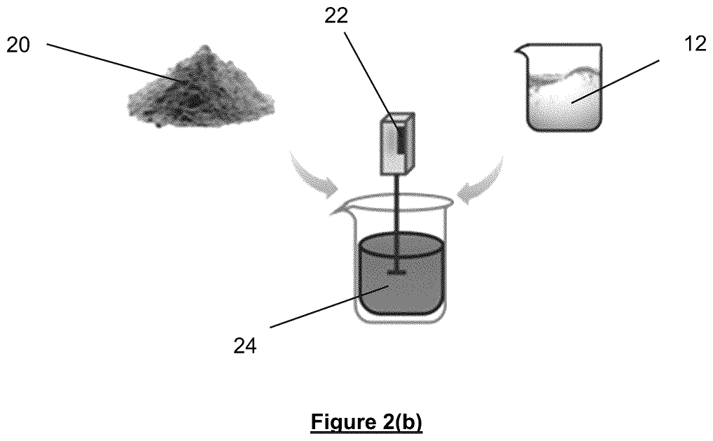

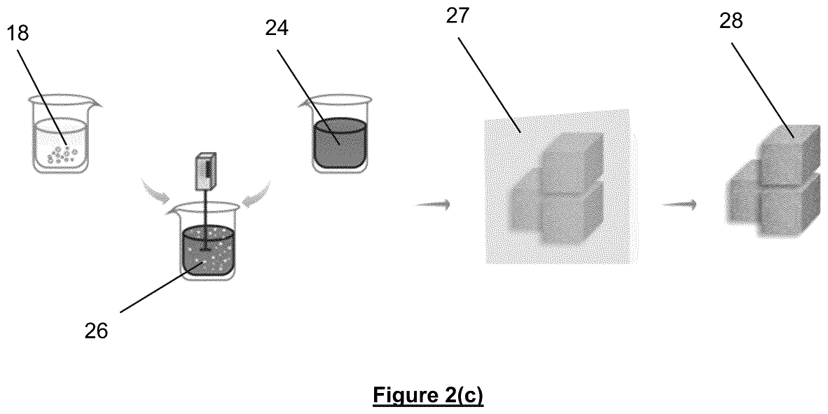

After material preparation, the manufacturing process of the foam concrete composition and the foam concrete according to the present invention, as shown in FIGS. 2(a) to 2(c), were started.

As shown in FIG. 2(a), the foaming agent 10 was blended/mixed with a diluted solution of water 12 (such as tap water) and UEO 14. The mixture was then stirred, for example with a handheld electric mixer 16, at a speed of 700 r/min for 5 minutes to generate UEO-enhanced foam mixtures 18.

Separately, LC³ cement 20 was mixed with water 12 (such as tap water); and the mixture was then stirred, for example by a handheld electric mixer 22, for 5 minutes to attain a well-mixed cement paste 24, as shown in FIG. 2(b).

As shown in FIG. 2(c), the UEO-enhanced foam mixture 18 was mixed with the cement paste mixture 24, and the mixture was blended until no visible traces of white foam remained, indicating a homogeneous UEO-enhanced cement paste mixture 26. The resultant UEO-enhanced cement paste mixture 26 was then carefully poured into steel molds and allowed to cure for one day for proper cement hardening, to form UEO-enhanced foam concrete 28. During the curing process, a plastic foil 27 was applied to cover the mold opening to prevent excessive heat and moisture loss. Alternatively, an aluminum foil may instead be used. While plastic film is commonly used to cover the mold during the initial curing process in order to prevent moisture loss, aluminum foil can also be used for the same purpose, such as when higher thermal insulation is needed to regulate the curing temperature.

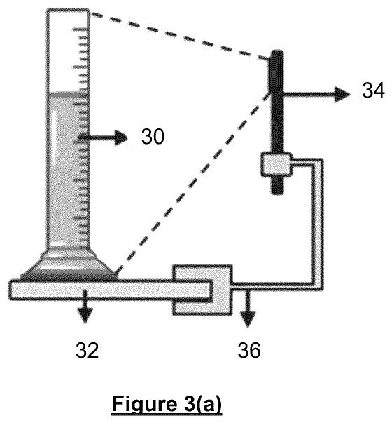

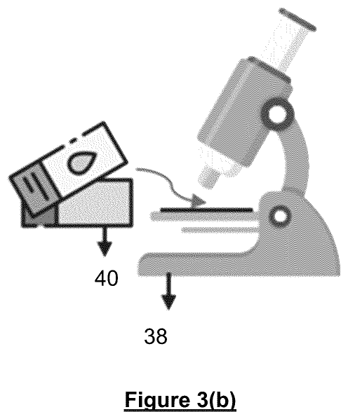

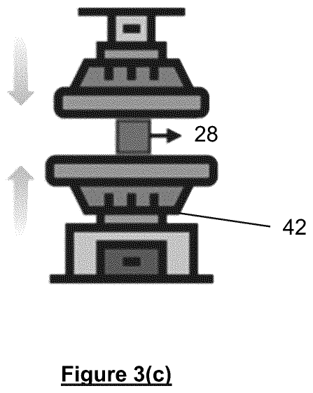

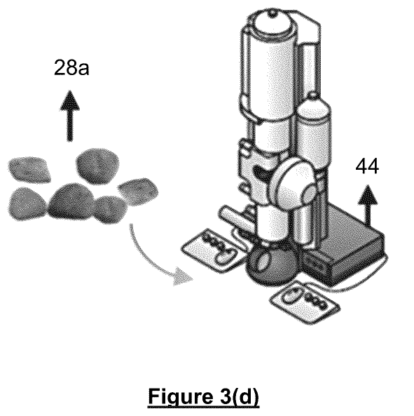

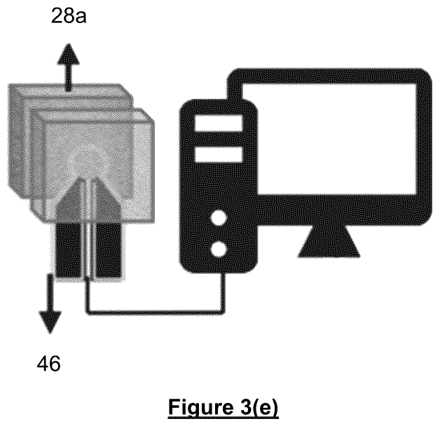

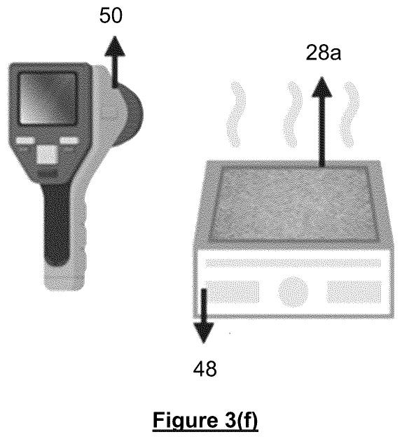

The stability of the prepared UEO-enhanced foam mixture 18 was characterized by the initial foam volume and its drainage rate over time. Immediately after preparation, the foam 18 was poured into a 250-mL graduated cylinder 30 standing on a stable support 32 (such as a desk). The volume of the bottom liquid was recorded within 120 minutes, as shown in FIG. 3(a), by an apparatus 34 with video recording capability, such as a smart phone, which was held stationary relative to the support 32 by a holder 36. Specifically, the foam drainage was calculated as the recorded volume divided by 250 mL, multiplied by 100%.

The microstructural characteristics of the freshly prepared UEO-enhanced foam mixtures 18, such as foam size and thickness of the Plateau border, were analyzed using an electron microscope 38 (e.g., Nikon SMZ800N) with a digital imaging solution at room temperature, as shown in FIG. 3(b). This process was started by depositing a drop of the UEO-enhanced foam mixture 18 onto a microscope slide 40, using a pipette. A coverslip was then applied to minimize disruption of the mixture structure and prevent the formation of air bubbles. The prepared slides 40 were examined under the microscope 38 to study their microstructural features and capture corresponding images.

The compressive strength of the foam concrete 28 was evaluated through compressive tests using a Universal Testing Machine 42 with a loading speed of 1.7 kN/s until failure, as specified by ASTM C109, and as shown in FIG. 3(c). The average of the values from three tested specimens was considered the final compressive strength.

After the above test, fragments of cement paste specimens 28a were collected to prepare SEM samples for evaluating the microstructural characteristics of the foam concrete 28. To halt cement hydration, the samples 28a were soaked in isopropanol for 24 hours and were then dried using a vacuum pump for three days at 55° C. to eliminate residual moisture. The treated samples 28a were then affixed to a conductive adhesive and underwent gold sputtering via an SC7620 mini sputter coater for high-resolution imaging. As shown in FIG. 3(d), SEM analysis was performed using a ZEISS Sigma 300 microscope 44, operating at an acceleration voltage of 3 kV, with a magnification range of 10-1,000,000 in selected regions. Quantitative analysis of the microscopic images was conducted using ImageJ software with the Fiji plugin.

The thermal performance of the foam concrete 28 was evaluated through a thermal conductivity test as shown in FIG. 3(e) and a macroscopic thermal insulation test as shown in FIG. 3(f). The thermal conductivity of the concrete samples 28a, sized 50 mm×50 mm×25 mm, was tested using a Hot Disk TPS 2500S thermal constant analyzer with a thermal sensor 46, in accordance with EN ISO 22007-2. Before testing, the samples 28a were heated in an oven at 55° C. for 72 hours to achieve a constant weight, minimizing the effect of moisture on measurement accuracy. During the measurement, the sensor 46 was placed between two pieces of the sample 28a, ensuring that flat sides were in contact with the sensor 46. Three random locations on the samples 28a were selected for testing. For visual evaluation of the thermal insulation capability of the foam concrete 28, a thermal plate testing setup with a heater 48 was set up to detect the side surface temperature of the samples 28a using an infrared thermal imager 50.

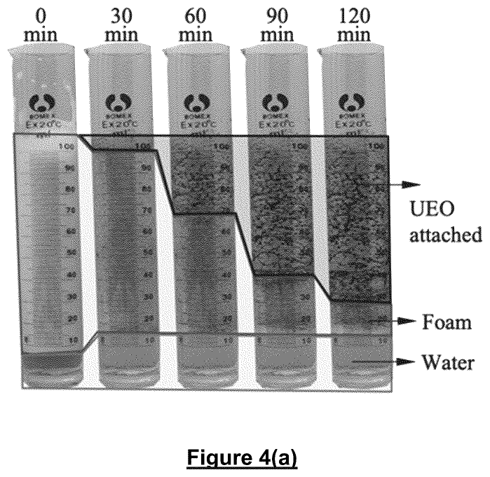

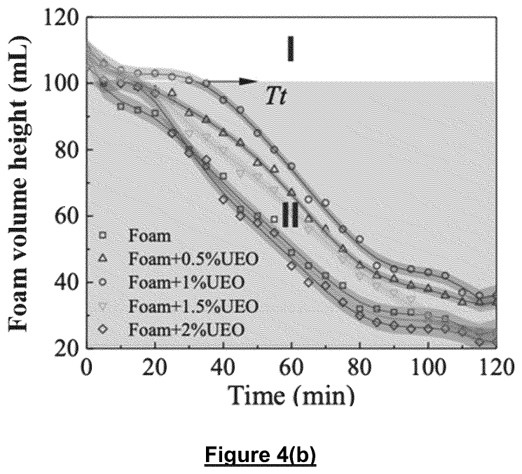

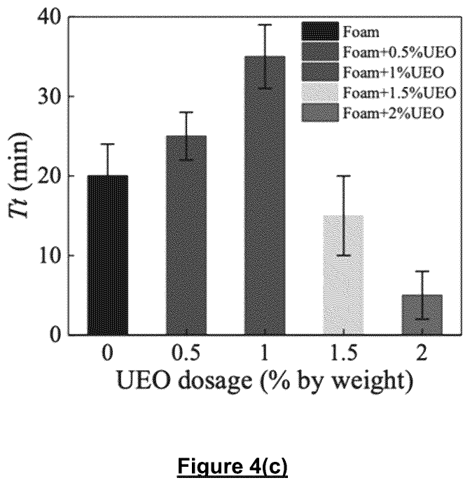

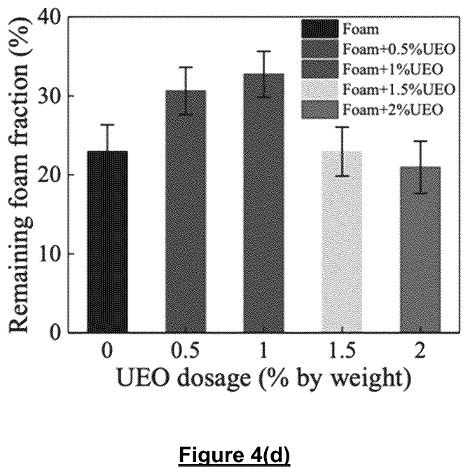

The effect of UEO on foam stability is evaluated in terms of alterations in foam volume, the critical onset of the foam collapse, and the remaining foam fraction, the details of which are shown in FIGS. 4(a) to 4(d). Specifically, FIG. 4(a) provides an overall depiction of foam volume evaluation over time, where the foam volume was found to decrease as time elapsed. As shown in FIG. 4(b), the foam drainage behaviors can be bifurcated into two distinct regimes, labeled as I and II. This segmentation aligns with the behavior observed in foam systems integrated with super chaotropic nano-ions. In Regime I, the foam volume experienced a rapid decline, attributed to the gravity-driven liquid drainage process. Intriguingly, a plateau was observed in foam with 1 wt. % UEO (i.e., 1% of the total weight of the foam generated), signaling a temporary stability in the foam state. During this phase, the liquid drainage rate was reduced to a minimum and the foam bubbles manifested self-similar growth due to bubble Ostwald ripening and coalescence. Following this phase, the foam transitioned to Regime II, indicating the advanced age of the foam, wherein a significant collapse was observed. The onset of foam collapse between Regimes I and II was represented by Tt. To demonstrate the effect of UEO dosage on Tt, FIG. 4(c) quantitatively depicts the correlation between UEO dosage and Tt. Clearly, as opposed to the pure foam, which had a Tt of 20 minutes, the foam infused with 1 wt. % UEO demonstrated the most extended Tt, enduring for 35 minutes. Increasing the UEO dosage beyond the optimal level of 1 wt. % (i.e., 1% of the total weight of the foam generated), e.g., from 1.5 wt. % to 2 wt. % (both with respect to the total weight of the foam generated), resulted in a contraction of the Tt value from 15 to 10 minutes. Beyond the evaluation of the critical Tt value, the relationship between the remaining foam fraction and the UEO dosage level are shown in FIG. 4(d). Remarkably, the foam with 1 wt. % UEO retained the largest remaining foam fraction, namely, 32%, during the 120-minute measurement. Conversely, the foam containing 2 wt. % UEO showed a lower remaining foam fraction of 21% compared to the foam devoid of UEO, which maintained a fraction of 23%. These measurements collectively indicate that an appropriate UEO dosage, specifically 1 wt. %, facilitates foam stabilization. However, an increase in UEO dosage beyond this optimal threshold degrades foam stability.

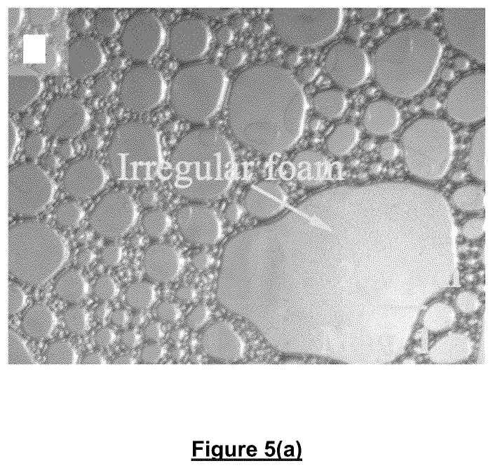

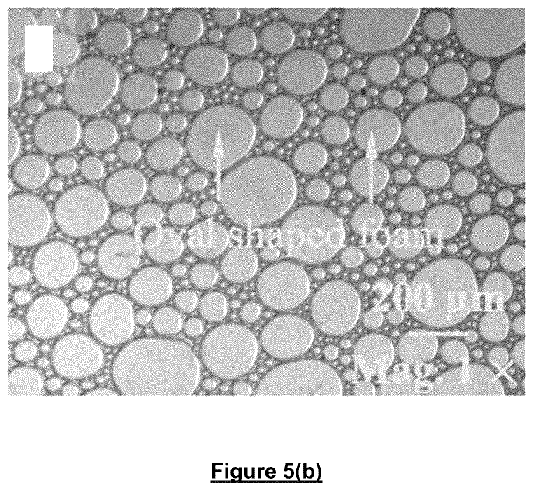

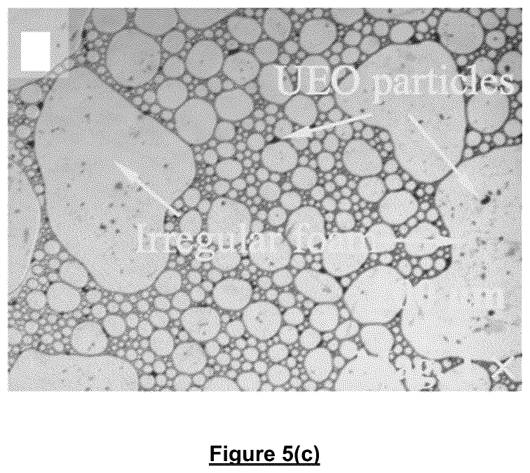

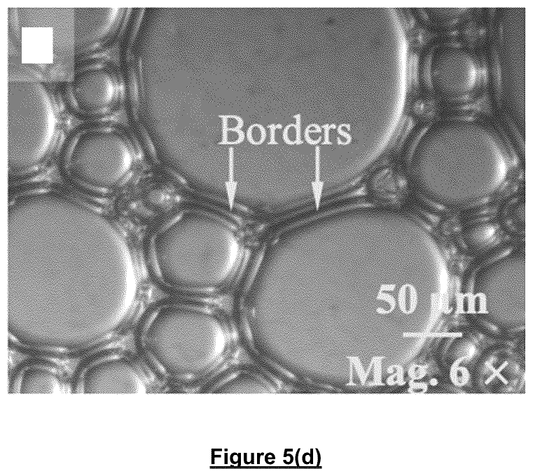

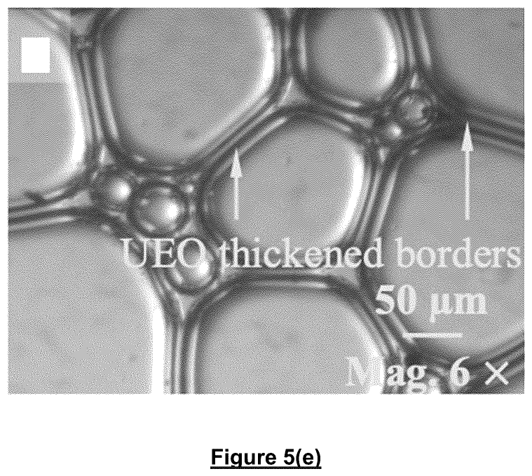

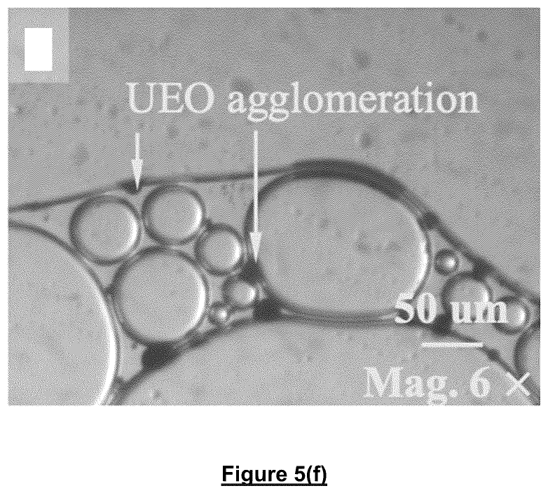

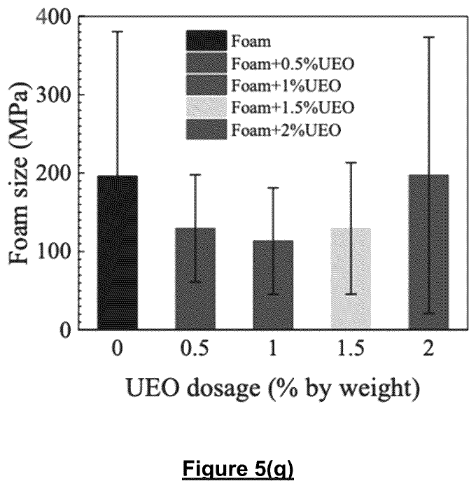

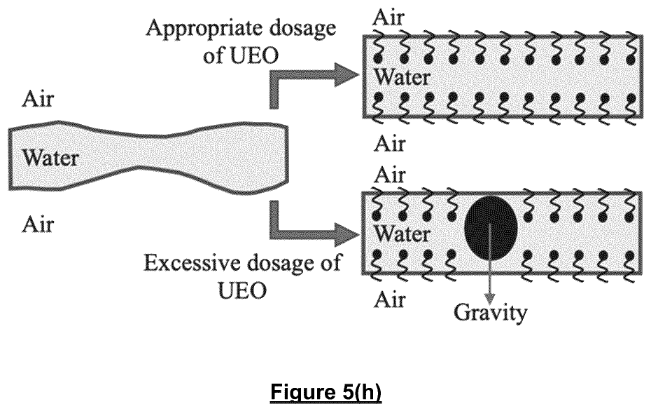

The stability of foams is intimately connected to their microstructural features. To uncover the covert mechanisms contributing to alterations in the stability of foams containing UEO, foam changes in terms of structure and size at the microscopic level were examined, as shown in FIGS. 5(a) to 5(h). Notably, in comparison to the pure foam shown in FIGS. 5(a) and 5(d), UEO-fortified foam shows a distinctive black appearance in FIGS. 5(b) and 5(c). Such implies that the UEO was absorbed onto the gas-liquid interface, thereby facilitating the development of thicker and more robust interface films within the foam as shown in FIG. 5(e). Specifically, at millimolar concentrations, UEO served to stabilize non-ionic surfactant foams through the generation of electrostatic repulsions between foam film interfaces, leading to the formation of thicker and uniformly sized foam films. This robust film contributed to enhanced liquid film strength and increased resistance to bubble deformation in the foam. Alongside changes in the film thickness, significant changes in film size were also observed as UEO concentrations escalated. Remarkably, the pure foam, synthesized without UEO, exhibited non-uniform structures with large sizes, approximately 195 micrometers, as shown in FIG. 5(g). In contrast, the inclusion of UEO at a concentration of 1 wt. % resulted in a decrease in foam size, yielding more uniform structures, measuring between 100 and 110 micrometers, as shown in FIG. 5(g). The emergence of small and uniform foams can be attributed to the dispersion effect of UEO. Furthermore, the integration of UEO promoted surface charging in the foams, including electrostatic repulsion between opposing interfaces. Consequently, the thickened gas-liquid interfaces contributed to an extended self-growth lifespan in Regime I and enhanced form stability. However, excessively high concentrations of UEO triggered agglomeration, imposing significant self-weight on foam structures and leading to unstable foam configurations, as shown in FIG. 5(h). Similar concentration-dependent foam stability was also observed in other foam stabilizers such as nonclay and Keggin ion. These findings clearly illustrate that the foam stability was contingent upon the level of UEO addition. Specifically, an optimal dosage of UEO resulted in uniform structure sizes and thicker structure boundaries of foams, ultimately promoting enhanced foam stability.

To assess the practicality of utilizing UEO-enhanced foam in the fabrication of foam concrete, the effect of the as-synthesized foam on the macroscopic performance, namely the compressive strength and thermal insulation performance, of the foam concrete 28 was investigated. These parameters are of paramount importance, considering the intended application of the foam concrete as thermal insulation material for walls, roofs, and floors.

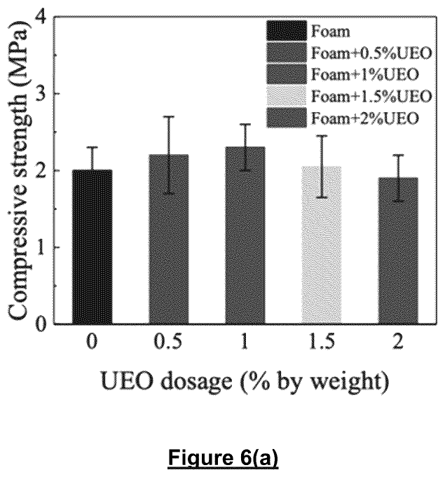

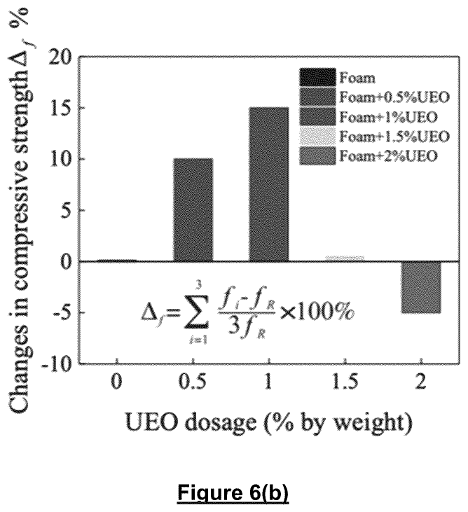

To begin with, the compressive strength of the developed foam concrete with various UEO dosage levels was compared to that of the reference foam concrete without UEO; the comparison results are shown in FIGS. 6(a) and 6(b). In the formula in FIG. 6(b), fᵢ and f_{R} denote the compressive strengths of concrete with and without UEO respectively. The change, Δ_{f}, was determined by summing (fᵢ−f_{R})/3f_{R}, times 100%. In these UEO-enhanced foam concrete systems, the compressive strength exhibited an elevation relative to the reference samples when the UEO addition level was confined to less than 2 wt. %. In particular, the foam concrete containing 1 wt. % UEO (designated as U10) displayed a maximum increment of approximately 15% in compressive strength of 2.3 MPa. This enhancement can be ascribed to the formation of uniform foam structures facilitated by the presence of UEO, as expounded in previous discussions. The uniform UEO-enhanced foams fostered a homogenous matrix in the foam concrete, characterized by an optimized pore packing pattern, thereby augmenting its mechanical performance. However, a significant decrease in the compressive strength of foam concrete was observed when the UEO addition level exceeded 1 wt. %. This reduced compressive strength can be attributed to UEO agglomeration, induced by its excessive addition. These poorly dispersed UEO particles, in the form of liquid, occupy certain portions of foam concrete, culminating in the creation of un-hydrated and non-uniform cement matrices. These deleterious internal phase compositions within foam concrete account for its diminished compressive strength. The above observations and interpretations suggest that the incorporation of 1 wt. % UEO is optimal for boosting the compressive strength of foam concrete, while a 2 wt. % UEO addition is ideal for maximizing the UEO recycling potential. Furthermore, it is noteworthy that the technical feasibility of upcycling UEO in the production of foam concrete has been established, considering the observed enhancement in the compressive strength of foam concrete.

In addition to the compressive strength, the thermal conductivity coefficients of the developed foam concrete and the reference concrete were also compared, the results of which are outlined in Table 3. Relative to the reference foam concrete sample without UEO, the thermal conductivity coefficient decreased by 1.75% and 12.8% with the incorporation of 0.5 wt. % and 1 wt. % UEO respectively. Notably, the concrete sample containing 1 wt. % UEO exhibited the lowest thermal conductivity coefficient of 0.162 W·m⁻¹K⁻¹, a reduction of approximately 16% in comparison to the reference sample. This decrement can be attributed to the formation of uniform air voids in the foam concrete facilitated by UEO as a foam stabilizer. These uniform air voids are beneficial pore structure features in the foam concrete, as they retard heat loss and improve thermal insulation performance. Moreover, UEO imparts an added advantage by serving as a dispersion agent due to the presence of sulfonate groups, which further enhances the uniformity of the foam structure. However, the thermal conductivity coefficient increased when the UEO addition level exceeded 1 wt. %. This increase can be linked to the agglomeration of UEO particles, resulting in a poorly dispersed internal structure in the foam concrete that promotes heat transfer and lowers its thermal insulation performance. These findings indicate that upcycling UEO in foam concrete can enhance its thermal insulation properties, contributing to energy conservation and mitigating greenhouse gas emissions in green buildings.

TABLE 3
Thermal conductivity coefficient of
foam concrete with and without UEO

| | Thermal conductivity | |
|---|---|---|
| Sample | coefficient (W · m⁻¹K⁻¹) | Standard Deviation |
| U0 | 0.195 | 0.03 |
| U05 | 0.172 | 0.02 |
| U10 | 0.162 | 0.03 |
| U15 | 0.194 | 0.04 |
| U20 | 0.261 | 0.03 |

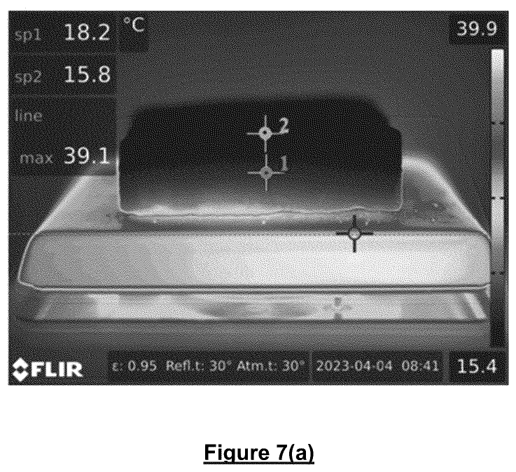

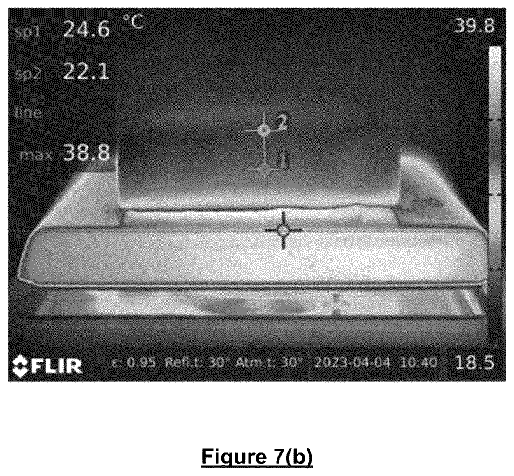

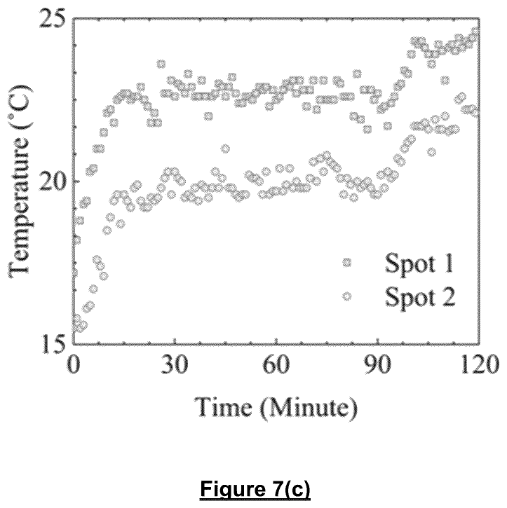

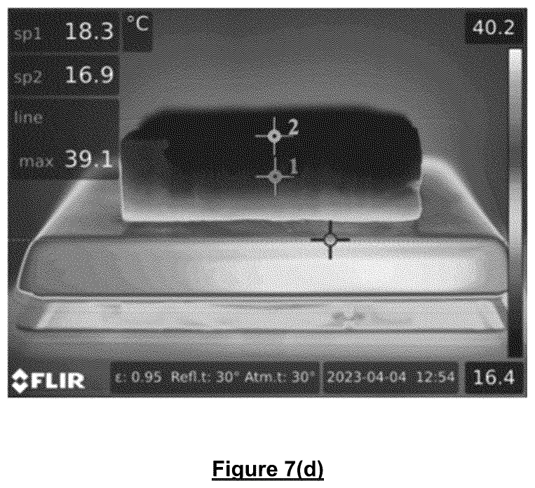

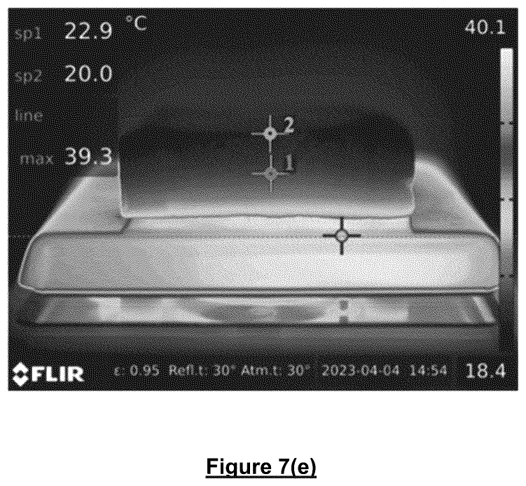

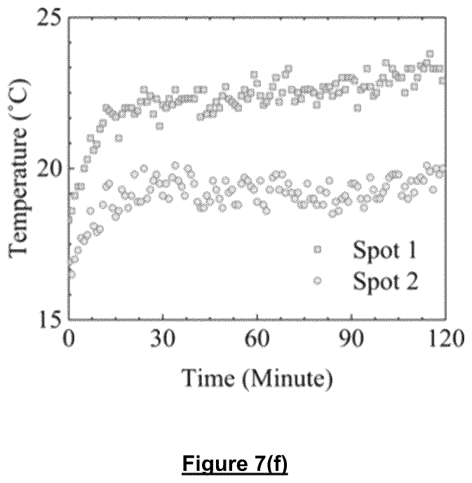

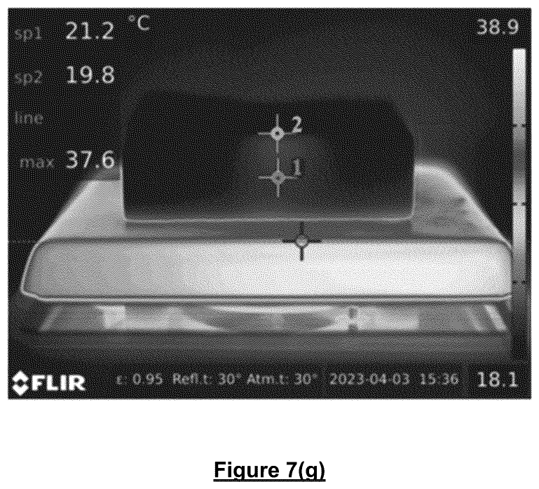

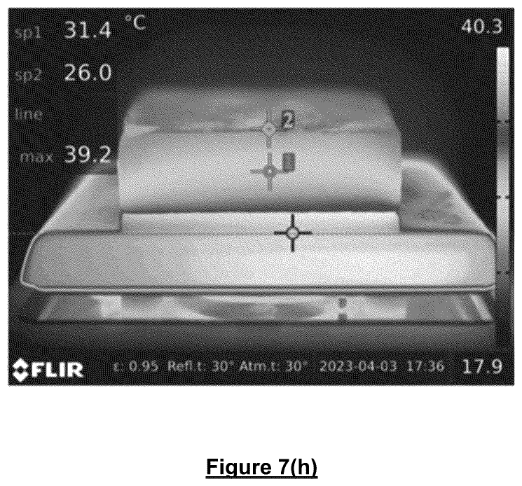

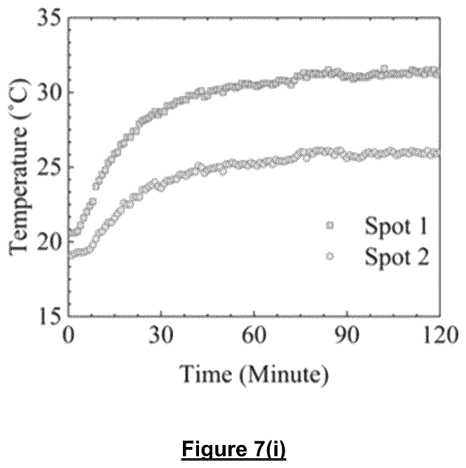

To visualize directly the effectiveness of the UEO-enhanced lightweight LC³ foam concrete 28 as a thermal barrier, an infrared thermal imaging camera was used to map the temperature distribution of the foam concrete 28, as illustrated in FIGS. 7(a) to 7(i). Notably, during the two-hour heat penetration period, foam concrete U10 registered the lowest temperatures at spots 1 and 2, 20.0° C. and 22.9° C. respectively, as shown in FIGS. 7(a) and 7(b). Conversely, the reference concrete without UEO recorded higher temperatures at the equivalent spots, 22.1° C. and 24.6° C. respectively, as shown in FIGS. 7(d) and 7(e). In addition, foam concrete U10 exhibited a temperature difference of approximately 4° C. between spots 1 and 2 in FIG. 7(c); this was greater than that of the reference samples, which had a temperature difference of around 3° C. as shown in FIG. 7(f). These temperature variations suggest that incorporating an appropriate quantity of UEO can effectively impede external heat source penetration and consequently enhance the thermal insulation performance of foam concrete.

To demonstrate further the advantages of foam concrete over normal concrete, the temperature variation of a normal concrete plate was also measured.

Remarkably, the temperature on the surface of the normal concrete plate in FIGS. 7(g) and 7(h) was significantly higher than that of foam concrete. Following a two-hour heat penetration period, the temperature values at spots 1 and 2 were recorded as 26° C. and 31.4° C. respectively. These temperature values were considerably higher than those of the optimal foam concrete U10, indicating that normal concrete possesses inferior thermal insulation properties and is less effective at impeding heat penetration from external sources. These findings further underscore the potential benefits of UEO-enhanced foam concrete over traditional foam concrete without UEO and normal concrete in various construction applications, particularly in scenarios where thermal insulation is a critical factor. The superior thermal insulation properties of the developed foam concrete significantly reduce the need for heating and cooling energy, which can lead to significant cost savings and lower carbon emissions. Additionally, the lightweight nature of foam concrete provides handling, transportation, and reduced structural load benefits, making it a sustainable choice for many construction projects.

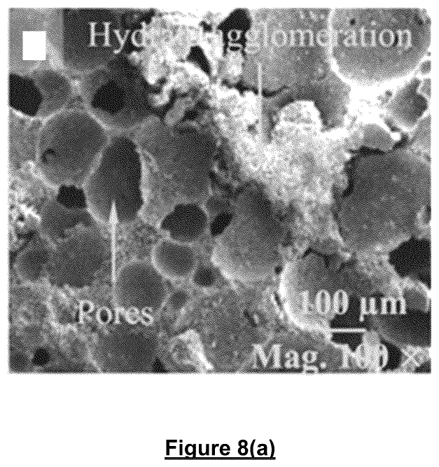

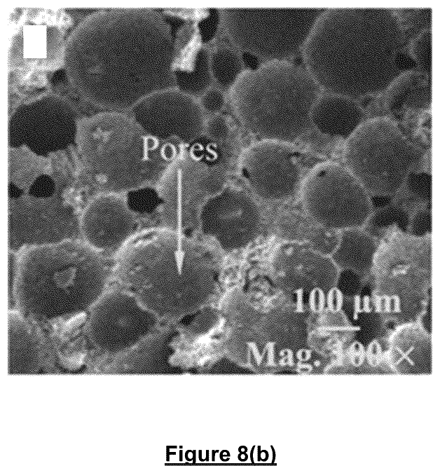

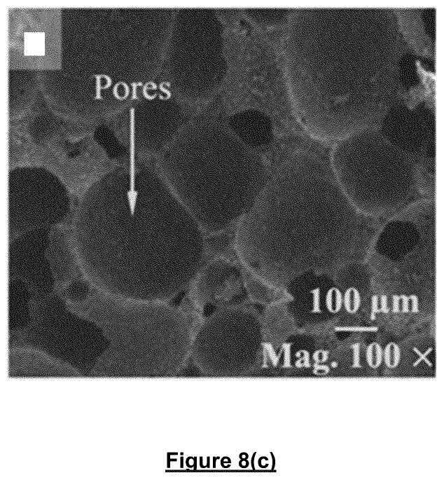

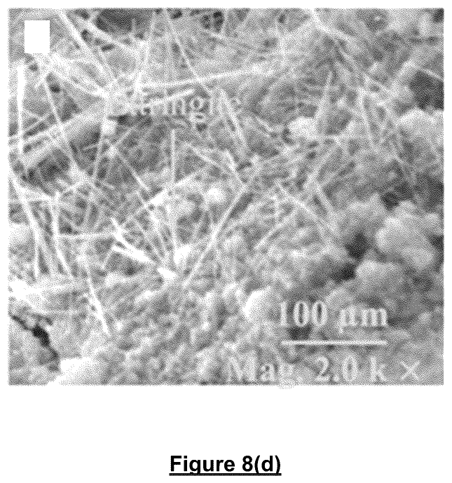

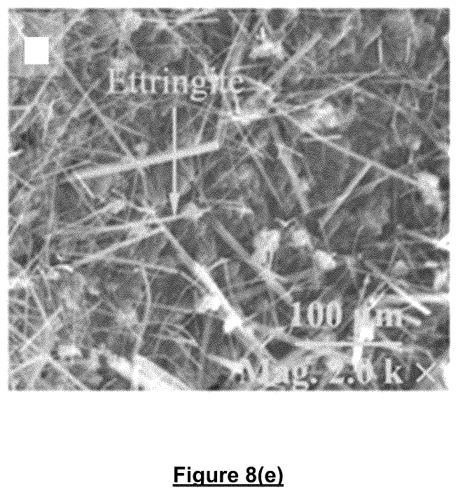

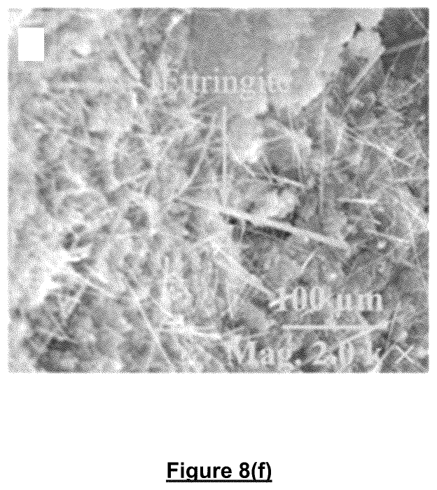

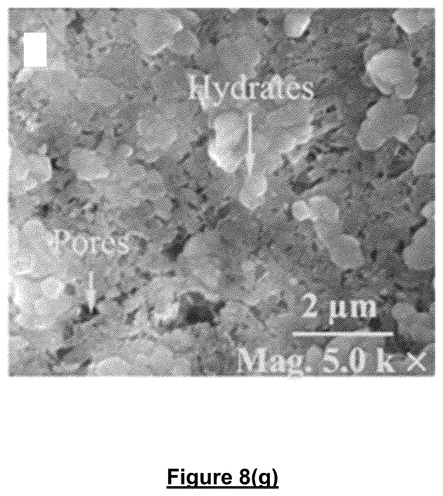

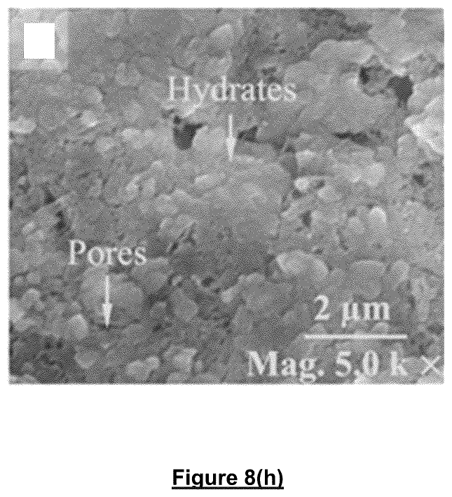

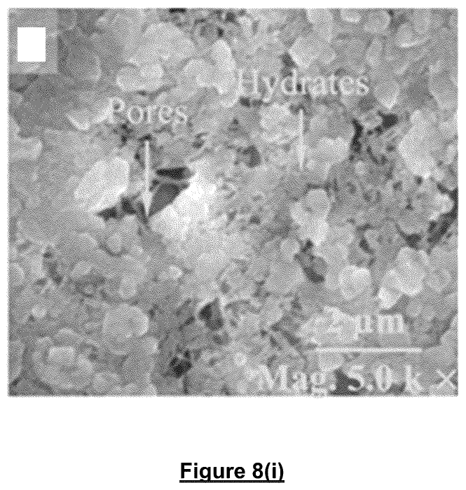

To elucidate the microscale origins behind the macroscopic performance change measured in the foam concrete 28, an in-depth exploration of its microstructural surface morphology was conducted, with the results shown in FIGS. 8(a) to 8(i). The microstructural features of the foam concrete 28, including pore characteristics and cement hydration products, were examined, as these are highly related to the thermal conductivity and compressive strength of foam concrete.

In contrast to the microstructural pores observed in the reference foam concrete as shown in FIG. 8(a) and the foam concrete with 2 wt. % UEO as shown in FIG. 8(c), the foam concrete with 1 wt. % UEO featured smaller and more homogeneous pores, as shown in FIG. 8(b). As a uniform pore size distribution is known to promote thermal insulation performance, these distinctive uniformly generated pores can impede heat loss, resulting in reduced thermal conductivity. In addition, the uniform inner structure reduces potential material failure due to homogeneity, thereby enhancing mechanical performance. The presence of uniformly scattered pores can be ascribed to the effective dispersion effect facilitated by UEO. Specifically, the sulfite ions in the UEO molecules can adsorb onto the surface of the UEO-enhanced foam, repelling each other within the cement paste and leading to an even distribution of pores. However, excessive UEO can introduce a defoaming agent, rapidly destroying the no-equilibrium foam systems. The adverse effect of UEO is the primary cause of foam breakages.

In addition to the pore characteristics, the development of cement hydrates on both the borders and inner surfaces of the foam-generated pore structures was examined. Remarkably, along the foam boundaries, a dense dispersion of ettringite crystals was observed in the concrete samples containing 1 wt. % UEO as shown in FIG. 8(e), in contrast to the pure foam concrete samples shown in FIG. 8(d) and the samples with 2 wt. % UEO shown in FIG. 8(f). This differential growth of cement hydrates suggests that the generated UEO-enhanced foam systems promote growth of hydrates. This effect can be linked to an increase in hydration reaction sites from the high specific surface area of these foam systems. The accelerated hydration process was another microstructural cue that enhanced the mechanical strength of the developed foam concrete, accelerating the hydration process and enhancing the mechanical strength of this concrete.

Regarding the inner surfaces of the foam-generated pores, the U10 foam concrete sample exhibited a highly packed microstructure; it had few pores with sizes of less than 1 μm and minimal cracks as shown in FIG. 8(h), unlike samples U0 shown in FIG. 8(g) and U20 shown in FIG. 8(i). This observation again implies that an appropriate UEO dosage refines the microstructure of foam concrete. The mechanisms are associated with the dosage-dependent properties of UEO. Specifically, adding a low or appropriate concentration of UEO can enhance hydration reaction sites for the cement hydration process due to the high specific surface areas of UEO. Furthermore, UEO can help disperse cement clinkers, promoting hydration. However, excessive UEO disrupts the foam systems by causing UEO agglomeration, leading to large pores in the microstructure of foam concrete. These microstructural interpretations demonstrate that the uniformly formed UEO-enhanced pore system and the UEO-promoted hydration process are the microscale origins behind the macroscopic performance enhancement of UEO-enhanced foam concrete.

In pursuing sustainable practices in the environmental and building sectors, a low-carbon, lightweight, waste-enhanced LC³ concrete formula was developed that reduces waste and decreases the use of virgin materials, making it a more sustainable building option. UEO is a potential foam stabilizer, as evidenced by the improved foam stability in the presence of UEO. In addition, incorporating an appropriate amount of upcycled UEO into foam concrete, specifically 1 wt. %, not only enhances its compressive strength by approximately 15% but also improves its thermal insulation properties, with a reduction of approximately 16% in the thermal conductivity coefficient compared to the reference sample. This performance enhancement is attributed to the uniform foam structures and promoted cement hydration resulting from UEO addition. In addition, utilizing an infrared thermal imaging camera, it was found that during a two-hour heat penetration test, UEO-enhanced foam concrete (U10) registered temperatures of 20.0° C. and 22.9° C. at two separate spots, which was significantly lower than the 26° C. and 31.4° C. recorded on a normal concrete plate; this demonstrates superior thermal insulation properties. The development of UEO-enhanced foam concrete highlights the potential for upcycling waste materials into valuable construction materials, contributing to sustainable and deep de-carbonization for the construction industry.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A foam concrete composition, including:
limestone calcined clay cement (LC³),
used engine oil (UEO),
a foaming agent, and
water.

2. The composition of claim 1, wherein said UEO is of from 0.5% to 2% by weight of foam generated.

3. The composition of claim 1, wherein said UEO is of a density of from 0.6 g/cm³ to 2.0 g/cm³.

4. The composition of claim 1, wherein said foaming agent includes sodium dodecyl sulfate and sodium alcohol ether sulphate.

5. The composition of claim 1, wherein
$$\frac{Weight of water}{Weight of {LC}^{3}}$$
is from 0.3 to 0.6.

6. The composition of claim 1, wherein said foaming agent is of a foaming ratio of from 1:30 to 1:50.

7. The composition of claim 1, wherein said LC³ includes ordinary Portland cement, calcined kaolinite clay, limestone, and gypsum.

8. The composition of claim 7, wherein the weight ratio amongst said ordinary Portland cement, said calcined kaolinite clay, said limestone, and said gypsum is about 50:30:15:5.

9. A foam concrete formed of a foam concrete composition according to claim 1.

10. A method of forming a foam concrete composition, including mixing limestone calcined clay cement (LC³), used engine oil (UEO), a foaming agent and water.

11. The method of claim 10, including:
mixing said foaming agent, said UEO and said water to form a UEO-enhanced foam mixture;
mixing said LC³ and said water to form an LC³ cement mixture; and
mixing said UEO-enhanced foam mixture and said LC³ cement mixture.

12. The method of claim 11, wherein mixing said foaming agent, said UEO and said water is carried out by mixing said foaming agent with a solution of said water and said UEO.

13. The method of claim 12, wherein said UEO is from 0.5% to 2% by weight of foam generated.

14. The method of claim 11, including mixing said UEO-enhanced foam mixture and said LC³ cement mixture until no visible traces of foam remain.

15. A method of forming a foam concrete, including forming a foam concrete composition according to claim 9.

16. The method of claim 15, further including curing said foam concrete composition.

17. The method of claim 16, further including:
pouring said foam concrete composition into a mold for curing; and
covering an opening of said mold with a plastic foil or an aluminum foil during curing.
